(19) United States
(12) Patent Application Publication
(10) Pub. No.: US 2017/0091400 A1
(43) Pub. Date: Mar. 30, 2017

(54) SYSTEMS AND METHODS FOR LINKING MEDICAL RECORDS WITHIN CLAIM MESSAGES

(71) Applicant: Olah Healthcare Technology, Inc., Columbus, OH (US)

(72) Inventors: Frederick Ray Richards, Hilliard, OH (US); Brian David Olah, New Albany, OH (US)

(21) Appl. No.: 14/865,506

(22) Filed: Sep. 25, 2015

(51) Int. Cl. G06F 19/00

(52) U.S. Cl. CPC G06F 19/328; G06F 19/322

(57) ABSTRACT

Systems and methods are provided for linking medical claims to a message. A system can comprise a linking component that links a personal health identifier to a set of clinical data, a generation component that generates a link comprising a set of characters representing the personal health identifier corresponding to a first subset of clinical data of the set of clinical data, wherein the generating the link is based on a first claim associated with the personal health identifier, and wherein the first subset of clinical data represents a limited set of clinical information corresponding to the first claim, a collection component that collects a set of descriptive information in response to a request to access the first subset of clinical data, and a messaging component that sends an electronic claim message comprising the link embedded within the electronic claim message and the set of descriptive information.

### TECHNICAL FIELD

This disclosure generally relates to messaging systems and methods that facilitate access to relevant data via one or more links.

### BACKGROUND

For years, the healthcare industry has faced problems related to the submission and adjudication of health plan insurance claims. Although, most claims for providers are processed and managed via electronic claim management systems (often owned by intermediary clearing houses, hereinafter referred to as “vendors”), a major problem persists relating to the inability for health plans for some insurance claims to be automatically adjudicated on the “first pass” (e.g., the first time a claim is submitted for adjudication) via an adjudication process. Those claims that are not automatically adjudicated are processed with manual intervention (e.g., manual document assembly to satisfy the claim payment requirements), which requires a greater processing time and greater cost to the healthcare provider (“providers”) and health plan providers (“payers”). A common reason for rejection of a claim to be processed automatically is a need by the payer to validate clinical data to substantiate the payment of the submitted insurance claim.

For every rejected claim, there is an extension in time of approximately two to four weeks between the date of the submitted claim and the date of payment to the provider. The provider is also burdened by a delay in processing times and increased processing costs for insurance claims that fail to be processed and paid on the first pass. Despite the improvement of the “first pass rate” (e.g., the rate with which claims are paid out on the first pass) over the past ten years from around 80% to 97% of submitted claims, it is anticipated that upcoming mandatory regulations to implement new code sets (e.g., The International Statistical Classification of Diseases and Related Health Problems, 10th Revision, Clinical Modification, referred to as “ICD-10 CM” or “ICD-10”, which is another coding classification) will decrease the first pass rate thereby affecting payers, providers and vendors. The ICD-10 CM code sets will be used by providers to code diagnoses, symptoms, and procedures recorded in hospitals, physician practices, and other such provider locations.

Furthermore, regardless of whether the first pass rate increases, the current process still exposes a claim to the possibility of suspension even after the claim passes a vendors edits and moves to adjudication because of the payers request to justify the claim (e.g., suspended claim) via clinical documentation. The current rate of suspension of claims is approximately 3%, where suspended claims require additional clinical information to justify the claim payment. Based on an anticipated change in payment methods under ICD-10 CM, which will pay varying fees for surgical procedures depending on the complexity of the procedure as reflected in the new coding, it is expected that an additional 3-7% of claims will be suspended for requiring additional clinical data.

Currently, payers must request data from the provider because of a federal law known as the Minimum Necessary Requirement, where the payer is not allowed to access or possess the data until they prove the data is required to determine a payment amount for a claim. The Minimum Necessary Rule is part of the Health Information Technology for Economic and Clinical Health Act (HITECH Act), which was implemented in 2009 to promote the adoption and meaningful use of health information technology. The Minimum Necessary Requirement requires covered entities to take reasonable steps to limit the use or disclosure of, and requests for, protected health information to information that is minimally necessary to accomplish the intended purpose (e.g., determine a payment amount for a claim or determine whether a claim is justified). Additionally, current business practices have payers receiving requested data (e.g., the minimum necessary data required to justify a claim) by fax, which is inefficient and takes additional time and resources to perform.

Given the problems outlined above, new solutions are required to overcome the changing regulatory environment, coding rules, and claim management inadequacies currently in place.

### SUMMARY

The following presents a simplified summary of the disclosure in order to provide a basic understanding of some aspects of the disclosure. This summary is not an extensive overview of the disclosure. It is intended to neither identify key or critical elements of the disclosure nor delineate any scope particular embodiments of the disclosure, or any scope of the claims. Its sole purpose is to present some concepts of the disclosure in a simplified form as a prelude to the more detailed description that is presented later.

In accordance with one or more embodiments and corresponding disclosure, various non-limiting aspects are described in connection with linking medical records within claim messages are disclosed. In accordance with a non-limiting embodiment, in an aspect, a system is provided comprising a processor, communicatively coupled to a memory, that executes or facilitates execution of executable components stored in a non-transitory computer readable medium, the executable components comprising: a linking component that links a personal health identifier to a set of clinical data; a generation component that generates a link comprising a set of characters representing the personal health identifier corresponding to a first subset of clinical data of the set of clinical data, wherein the generating the link is based on a first claim associated with the personal health identifier, and wherein the first subset of clinical data represents a limited set of clinical information corresponding to the first claim; a collection component that collects a set of descriptive information in response to a request to access the first subset of clinical data: and a messaging component that sends an electronic claim message comprising the link embedded within the electronic claim message and the set of descriptive information.

In various aspects, the system further comprises a security component that receives requests to access the first subset of clinical data and a submitted access key. In another aspect, the system comprises a permission component that permits access to the first subset of clinical data in response to the security component receiving a valid access key, wherein the valid access key is a provider certificate. Furthermore, in an aspect, the system can comprise an archive component that archives the set of clinical data, the subsets of clinical data, and the set of insurance claims at the data repository.

The disclosure further discloses a method, comprising linking, by a system comprising a processor, a personal health identifier to a set of clinical data; generating, by the system, a link comprising a set of characters representing the personal health identifier corresponding to a first subset of clinical data of the set of clinical data, wherein the generating the link is based on a first insurance claim associated with the personal health identifier, and wherein the first subset of clinical data represents a limited set of clinical information associated with the first insurance claim; collecting, by the system, a set of descriptive information in response to a request to access the first subset of clinical data; and sending, by the system, a claim message comprising the link and the set of descriptive information.

The following description and the annexed drawings set forth certain illustrative aspects of the disclosure. These aspects are indicative, however, of but a few of the various ways in which the principles of the disclosure may be employed. Other advantages and novel features of the disclosure will become apparent from the following detailed description of the disclosure when considered in conjunction with the drawings.

### BRIEF DESCRIPTION OF THE DRAWINGS

FIG. 1 illustrates an example non-limiting system for linking a subset of data corresponding to an insurance claim using a message.

FIG. 2 illustrates an example non-limiting system for linking a subset of data corresponding to an insurance claim using a message.

FIG. 3 illustrates an example non-limiting system for linking a subset of data corresponding to an insurance claim using a message.

FIG. 4 illustrates an example non-limiting system for linking a subset of data corresponding to an insurance claim using a message.

FIG. 5 illustrates an example non-limiting system for linking a subset of data corresponding to an insurance claim using a message.

FIG. 6 illustrates an example non-limiting system for linking a subset of data corresponding to an insurance claim using a message.

FIG. 7 illustrates an example non-limiting method for linking a subset of data corresponding to an insurance claim using a message.

FIG. 8 illustrates an example non-limiting method for linking a subset of data corresponding to an insurance claim using a message.

FIG. 9. illustrates an example non-limiting method for linking a subset of data corresponding to an insurance claim using a message.

FIG. 10 illustrates an example non-limiting method for linking a subset of data corresponding to an insurance claim using a message.

FIG. 11 illustrates an example non-limiting method for linking a subset of data corresponding to an insurance claim using a message.

FIG. 12 illustrates an example non-limiting method for linking a subset of data corresponding to an insurance claim using a message.

FIG. 13 is a block diagram representing an exemplary non-limiting networked environment in which the various embodiments can be implemented.

FIG. 14 is a block diagram representing an exemplary non-limiting computing system or operating environment in which the various embodiments may be implemented.

### DETAILED DESCRIPTION

### Overview

The innovation is now described with reference to the drawings, wherein like reference numerals are used to refer to like elements throughout. In the following description, for purposes of explanation, numerous specific details are set forth in order to provide a thorough understanding of this innovation. It may be evident, however, that the innovation can be practiced without these specific details. In other instances, well-known structures and devices are shown in block diagram form in order to facilitate describing the innovation.

By way of introduction, the subject matter disclosed in this disclosure relates to embedding links within messages to providers that link to particular clinical data that supports a particular medical insurance claim. In an aspect, the system and methods address issues related to the upcoming changes of diagnosis code sets from ICD-9 to ICD-10, wherein the ICD-10 diagnosis code sets change the way insurance claims are paid for surgical procedures and other such medical services. Some of these issues, include, but are not limited to, the requirement to support many more insurance claims with clinical patient data related to the insurance claim, the requirement by a payer to prove the need for clinical data to determine an amount to pay for the medical insurance claim, and the healthcare provider providing the minimum amount of clinical data necessary required to satisfy the payer's payment determination needs (in accordance with the Minimum Necessary Rule of the HITEC Act). Furthermore, the systems and methods disclosed herein also address insurance claims in general including code sets other than ICD-10 (e.g., older and newer code set classification schemes) and including industries other than medical insurance claims as well.

One problem related to the issues outlined above relates to the payers need for information (e.g., patient clinical data) at the time of adjudication of the insurance claim. To be most efficient, the information needs to be available for an examiner employed by the payer at the first pass, which eliminates the need for the examiner to request the data from the provider. Currently, a provider uses a claim management system (e.g., sometimes administered and owned by an intermediate vendor such as a clearinghouse) to facilitate the organization, filing, updating, processing, storing of claim data, and billing practices associated with medical insurance claims. A claim is sent from the claim management system to a payer's adjudication system or adjudicator. If a claim is clean an electronic payment is issued and sent by the payer to the provider for the insurance claim (e.g., clean claims typically take up to 14 days for payment). If the claim is not clean, then the claim requires additional supporting documentation for payment to occur.

The process for an unclean claim requires assignment of the unclean claim to an examiner as well as a request for clinical data to support the claim and justify payment (e.g., 30 day process to assign to examiner and mail request for data to provider). This request for clinical data is currently a physical request followed by physical mailing of information from the provider. The provider then assigns the claim to a claim management specialist who manually assembles the documentation with the clinical data, and uploads the documentation via the payers website or prints and faxes the documentation to the payer. Some payers have websites with separate logins and passwords to upload the documentation. Upon receipt of the documentation, the payer submits the documentation for document imaging and it is placed in the examiner's review queue. The examiner reviews the document (e.g., the review can take up to 30 days) and if after receipt of the clinical data the claim is deemed clean then electronic payment is issued and sent by the payer (e.g., payment can take a total of 60-90 days). If the claim is still not deemed clean, the whole request process starts over.

This long arduous process for unclean claims leaves a provider with a balance sheet that must bear the unpaid submitted claims as accounts receivable for the period of time until the provider receives payment for the claim by the payer. Furthermore, with the implementation of the Minimum Necessary Rule, the process will require even more scrutiny in that only the provider must only send the minimum necessary documentation and data to justify a claim in response to a request for documentation by the payer. Sending unnecessary documentation is a potential heavy financial penalty to providers. The burden to providers goes further in that the ICD-10 overhaul will require more documentation procurement based on the complexity of procedures and associated insurance claims.

The providers also face problems, where by some accounts show physician, physician group, and hospital will need to keep on hand triple the current average accounts receivable due to the delay in processing times required by the current claims processing system. The providers depend on the revenue from claim payments to pay staff, continue operations, and generally function as a company. The payers also incur costs, dedicated resource allocation, and operational inefficiencies due to the current payment process as well as the upcoming ICD-10's implementation. Thus, the importance of sending necessary supporting clinical documentation with claim data at the first pass is of greater financial importance to both providers and payers.

Disclosed herein are systems and methods that provide solutions to the issues outlined above. The systems and methods can send a link to clinical data, by embedding the link in an electronic message in accordance with data formats corresponding to data interchange standards associated with the electronic message. The systems and methods can collect data and information about whom is requesting to access the clinical data, why they need to access the data (e.g., to substantiate payment for a claim submission) and when the data is accessed (e.g., logging dates and times of users logging in, accessing the data, and logging out). The systems and methods can be used by any provider, any payer (e.g., including payer's attached to specific clearinghouse's and those not attached to a clearinghouse), and any vendor. In another aspect, the systems and methods, can facilitate access to a data repository of clinical data, which in an embodiment, the clinical data can be organized by claim. The data repository can comprise the clinical data to support a specific claim, wherein the clinical data may not be a complete clinical record by only that information necessary to justify the claim (e.g., in compliance with the Minimum Necessary Rule).

In an embodiment, the systems and methods disclosed can embed links within messages following the implementation guidelines for the Accredited Standards Committee X12 (“ASC X12”). ASC X12 was chartered by the American National Standards Institute (ANSI), such that the X12 Electronic Data Interchange (EDI) and Context Inspired Component Architecture (CICA) standards along with XML schemas could facilitate business processes internationally, including insurance claim processes, processes utilizing healthcare standards (e.g., for providers), and health information exchanges processes. In an aspect, EDI X12 is a data format based on ASC X12 standards, wherein the standards are used to exchange specific data between two or more organizations that represent trading partners. Each release of standards by the ASC X12 contains a set of message types (e.g., invoice, purchase order, healthcare claim, etc.), and each message type is assigned a specific number. Every new release comprises a new version number and major new releases start with a new number. In an embodiment, the systems and methods disclosed herein can work with ASC X12 versions 4010, 4020, 4030, 5010, 5030, 6010, etc.

In embodiments, the disclosed systems and methods are compliant with EDI X12 standards such as requirements for data structure, separators, control numbers, and so on. In an aspect, disclosed embodiments also are compliant with rules and requirements set forth by specific trading partners, organizations, claim management systems, HIPAA and other such entities. In another embodiment, the disclosed systems and methods can be utilized to track medical records including images outside of an organization (e.g., outside of a physician office), which can facilitate the medical record (e.g., image) to be presented on the first pass to a payer. In another aspect, the disclosed systems and methods can embed links with claim messages following a host of different standards. For instance, the links can be embedded within messages following the Health Level 7 international standards. As such the link can be embedded within messages as following various different standards, guidelines, and systems.

In another embodiment, the disclosed systems and methods can be utilized by billing service providers, clearinghouses, vendors, intermediaries, or electronic medical record (EMR) providers. Any user that seeks to produce, manage, move or manipulate an insurance claim will find the systems and methods disclosed herein useful. The utility of the systems and methods disclosed herein are apparent in light of the prevalence of electronic claim data transfer. Furthermore, a federal law was passed in 1990 requiring providers to submit claims to payers instead of the patient, which resulted in the administrative processes and inefficiencies in the adjudication process as outlined above. With the X12 file format and flat file formats established in 1992, electronic submission of claim data has increased. Furthermore, in 2003 the HIPAA laws required all claims to be submitted in the 4010 X12 message format, which did away with the paper process of submitting claims. More recently, in 2009, the electronic claim messaging standards were updated to version 5010 of ASC X12 to fix many issues with the system. As such, now most claims are submitted electronically and those that are not is due to the requirement to submit clinical records with the claims, such that the claim and the clinical data are submitted together on paper. As the Centers for Medicare and Medicaid Services (CMS) currently manage 44,000 paper claims along with paper documentation each day, they bear tremendous costs and delays in processing times. The systems and methods disclosed herein will solve this problem and allow all claims to be submitted via electronic submission with the minimum required supporting clinical data to justify claim payment.

Example Systems and Methods for Linking Medical Records within Claim Messages

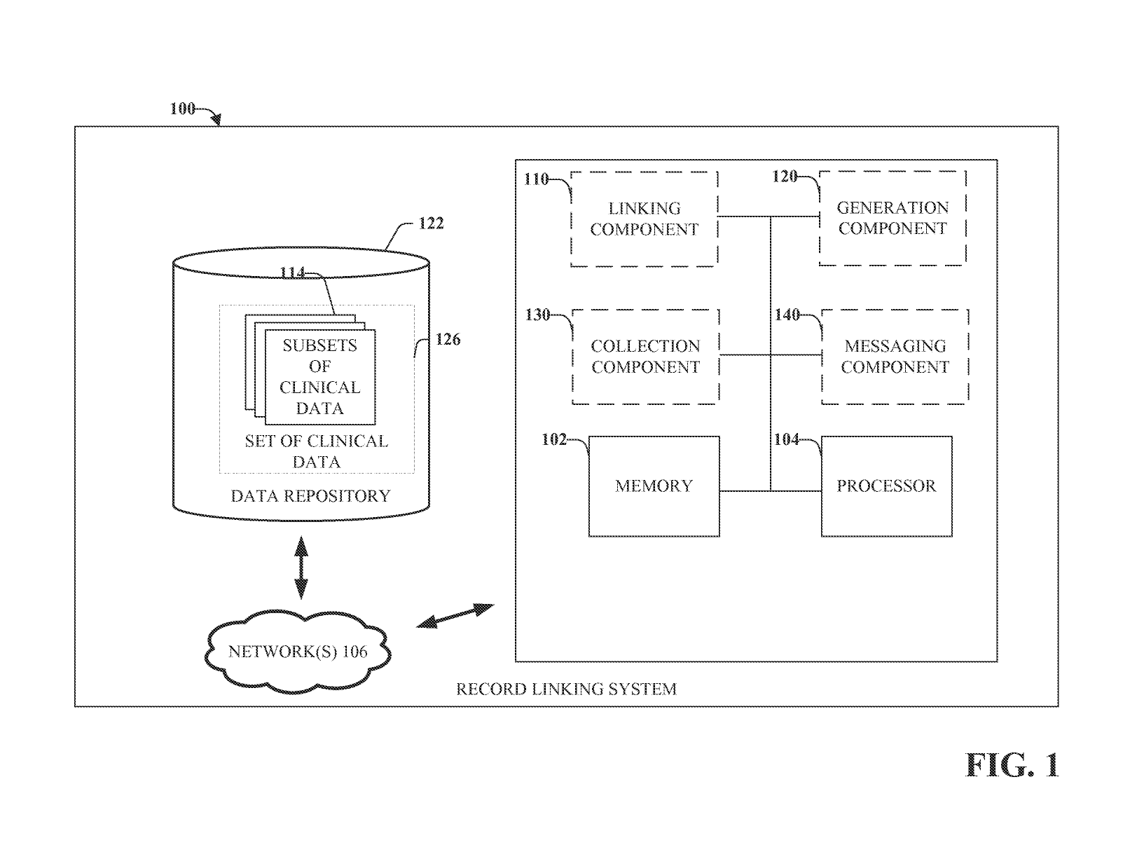

Referring now to the drawings, with reference initially to FIG. 1, linking system 100 is shown that facilitates linking medical records within a claim message. Aspects of systems, apparatuses or processes explained in this disclosure can constitute machine-executable component embodied within machine(s), e.g., embodied in one or more computer readable mediums (or media) associated with one or more machines. Such components, when executed by the one or more machines, e.g., computer(s), computing device(s), virtual machine(s), etc. can cause the machine(s) to perform the operations described.

System 100 includes memory 102 for storing computer executable components and instructions. A processor 104 can facilitate operation of the computer executable components and instructions by system 100. The various components of system 100 can be connected either directly or via one or more networks 106. Such network(s) can include wired and wireless networks, including but not limited to, a cellular network, a wide area network (WAN, e.g., the Internet), a local area network (LAN), or a personal area network (PAN). For example, messaging component 140 can communicate with data repository 122 (and vice versa) using virtually any desired wired or wireless technology, including, for example, cellular, WAN, wireless fidelity (Wi-Fi), Wi-Max, WLAN, and etc. In an aspect, one or more components of system 100 are configured to interact via disparate networks.

In an embodiment, system 100 employs a linking component 110, a generation component 120, a collection component 130, and a messaging component 140. In an aspect, linking component 110 links a personal health identifier to a set of clinical data 126. In an aspect, a personal health identifier or personal health information (PHI) can be information that identifies a patient such as a patient name, a medical record number, an account number, a certificate or license number, a phone number, social security number, biometric identifier, and other such identifiers. In another aspect, linking component 110 links a PHI to a set of clinical data 126. A set of clinical data 126 can be a body of information about the health status, the providing of health care, or the payment for health care associated with a particular individual or patient. For example, a set of clinical data 126 can comprise a patient's medical record, medical chart, documentation (e.g., of drugs administered, therapies or treatments rendered, test results, x-rays, reports, etc.), notes, recordings, and so on. Any single patient may have numerous PHI associated with the set of clinical data and numerous sets of clinical data associated with numerous PHI and patients can be stored at a data repository.

In another aspect, system 100 employs generation component 120 that generates a link comprising a set of characters representing the personal health identifier corresponding to a first subset of clinical data 114 of the set of clinical data 126, wherein the generating the link is based on a first claim associated with the personal health identifier, and wherein the first subset of clinical data 114 represents a limited set of clinical information corresponding to the first claim; In an aspect, the generated link (e.g., generated using generation component 120) can be associated with coded data, encrypted data, or de-identified data such that the data (e.g., sets of clinical data, subsets of clinical data, a first subset of clinical data, etc.) can be considered indirectly identifiable.

In an aspect, the generated link is a bridge to clinical data associated with a patient. The link generated using generation component 120 can comprise a set of characters (e.g., capital letters, numbers, periods, etc.). The link can be generated taking into account the requirements and standards (e.g., standards set forth by ASC X12 such as X12 EDI, CICA standards, XML schemas, etc.) of various data architectures and messaging architectures within various industries (e.g., healthcare, insurance, finance, etc.) such that the generated link is capable of being embedded within respective messaging architectures. For example, in an instance the generated link can be embedded within an ANSI ASC X12 837 claim message, such that the link comprises a combination of one or more capital letter, number, and period in various permuations, combinations, and orders acceptable to ANSI X12 837 system requirements and messaging formats.

In yet another aspect, the set of clinical data 126 is a body of medical information associated with respective patients. The set of clinical data 126 (also referred to as claim data, clinical information, or claim information) can comprise billing codes, codes that describe particular diagnoses, procedures, drugs, operations, electronical medical records (EMR), claim data, medical notes, or any other data associated with a patient and their interactions with health care providers (e.g., receiving services and products), and clinical information. In an aspect, a subset of clinical data is a portion of a patients set of data organized in a particular manner for a particular purpose. Thus a subset of clinical data (e.g., of the subsets of clinical data 114) can match up to a particular claim and comprise only that information required for the payer to issue payment for such claim. For example, a provider can submit a medical claim to a payer for an electrocardiogram (EKG) for a patient and a link can be generated (e.g., using generation component 120) corresponding to a subset of information that documents the provider conducting the (EKG). In another instance, a provider can submit a claim for mild depression and a link can be generated (e.g., using generation component 120) to a subset of clinical data that evidences the claim for mild depression such that a payer can issue payment to the provider.

In an aspect, the first subset of clinical data is the particular data or clinical information corresponding to a first claim. The first subset of clinical data satisfies the minimum necessary rule and also satisfies the payers requirements to issue payment. The first claim is a particular medical claim sought for payment or reimbursement from a payer. Furthermore, in an aspect, the first claim is associated with the PHI in that the first claim is a medical claim for health care services or products rendered to a person associated with the PHI.

In yet another aspect, system 100 employs collection component 130 that collects a set of descriptive information in response to a request to access the first subset of clinical data. As a user (e.g., claims adjudicator) clicks on the link to view the first subset of clinical data associated with a medical claim, the user will have to provide various information such as whom is requesting to access the data and why they seek to access the data. In an aspect, collection component 130 collects this descriptive information and is capable of logging as well as tracking such information. In an aspect, collection component 130 can facilitate the identification of persons (e.g., claim adjudicators working for the payer) or classes of persons (e.g., claim adjuicators, employees of the payer, insurance professionals, a covered entity, etc.) who require access to the clinical data to carry out their duties. Furthermore, for such clinical data that a person requires access, collection component 130 can facilitate a determination as to whether access to such data is needed and the conditions contributing to such access are appropriate to grant such access. The logging, tracking, and collecting features of collection component 130 along with the providing of reasonable efforts to limit access to clinical data contributes towards the system 100 satisfying some of the requirements of the Minimum Necessary Rule and increasing the first pass rate, by which claims are approved for payment at the first submission attempt.

In another aspect, system 100 employs messaging component 140 that sends an electronic claim message comprising the link embedded within the electronic claim message and the set of descriptive information. Another feature of system 100 is the messaging feature (e.g., using messaging component 140) which allows for the sending of the link that provides access to the first subset of clinical data. The sending of the message with embedded link can occur at various stages during the adjudication process depending on the particular process in place for a particular payer. In another aspect, the message can be sent through a health insurance provider (HISP) in some instances as necessary. Furthermore, the claim message can be sent through numerous clearinghouses and the link (as well as link location) is capable of passing the edits of each clearinghouse.

In an aspect, the standard, used in connection with the claim message, provides rules that allow for a limited set of characters to be provided in a link. The standard limits the use of certain characters because a claim message often passes through intermediaries (e.g., clearinghouses) prior to arriving to a payer. The intermediaries perform claim scrubbing or editing services, such as verifying that a medical claim and claim message does not contain errors and that the message is compatible with payer software. In another aspect, the clearinghouse will make sure that the submitted procedural and diagnosis codes are valid and appropriate for submission. The performance of such edits by clearinghouses prevents time-consuming processing errors from occurring. Also, a clearinghouse may use a system that is incompatible with a payer or provider. Accordingly the clearinghouse with an incompatible system may use another clearinghouse as well to pass the information through in order to meet system compatibility requirements.

As such, the link embedded within a claim message must be compatible with the payers systems, the providers system, and any clearinghouse system that receives the claim message along the journey from the prover to the payer. The standards of all such systems have in common the allowability of particular bit patterns associated with the link. The disclosed subject matter includes the one or more bit patterns allowable by all the systems and standards associated with such systems to allow a claim message embedded with a link to be transmitted to each system. The disclosed subject matter includes bit patterns used univerally by all systems (and software) and provides for a schema that allows a claim message with embedded link to travel via systems without being restricted or flagged as a message utilizing a limited bit pattern.

As a non-limiting example, a link embedded within a claim message may be sent from provider A using system 1 to clearinghouse B using system 1, from clearinghouse B to clearinghouse C using system 2, from clearinghouse C to clearinghouse D using system 3, from clearinghouse D to payer E using system 3. In such instance, the link can utilize a bit pattern or subset of bit patterns that compatible with system 1, 2 and 3 to allow the claim message with embedded link to be accessible at each location of provider A, clearinghouse B, clearinghouse C, clearinghouse D and payer E. In an aspect, the embedded link comprises only the bit pattern allowable to the systems of the provider, clearinghouses, intermediaries, and providers.

The embedded link also comprises a location code for routing a key to the specific clinical data subset (e.g., first subset of data specific to a particular claim). Since a patient may have multiple medical claims requiring multiple pieces of data or documentation, the key will be needed to access the relevant data for a particular claim. The data is located behind a firewall (e.g., the providers firewall), the key to access the particular data subset will only be effective behind such firewall. Thus the key has to be interpreted at two locations to be useful (e.g., at the location of the authorized user such as a payer and at the location of the data such as behind a provider's firewall). In an aspect, an embedded link may comprise numerous keys to facilitate access to particular data at different locations in accordance with a medical claim.

Furthermore, in an aspect, link embedded with the message contains a location for routing. When a user (e.g., a health plan) utilizes the link (e.g., clicks on the link), the disclosed system derives the location of the storage of the data (e.g., data repository 122, disparate data locations, etc.). The disclosed subject matter allows for the request to access data to be routed to various appropriate database (e.g., a hospital system may have a separate database for each of its many hospitals under its umbrella) depending on the medical claim and the location of the data associated with such claim. For instance, in an aspect, a link embedded in a claim message can potentially have numerous end points corresponding to various locations of stored data. For example, a link can have location A, B, and C as endpoint locations of the link, where each endpoint leads to a separate subset of data points.

In another aspect, the messaging system also allows for the sending of collected descriptive information (e.g., using collection component 130), to provide a layer of security before access is granted to the user attempting to access the clinical data. The claim message and link can be sent to shared claim partners in various formats (e.g., ANSI 837-5010) and returned in various claim formats (e.g., ANSI 835-5010). The claim message can be utilized in a range of EDI environments, by which, standards have been developed and implemented by organizations within the health care and health insurance industries.

The feature of system 100 sending a message (e.g., to a payer, employee, or directly into a document management system of a covered entity) comprising a link to a limited subset of clinical data (e.g., the first subset of clinical data relating to a patients' particular medical claim) at the time a claim examiner is adjudicating a claim provides significant time efficiencies and cost savings during the claim processing cycle. The claim examiner will no longer need to request the clinical data from the provider. Furthermore, because additional security and access restrictions will be in place, the clinical data will only be accessed by those requiring access (e.g., claim examiner). For instance, the clinical data and information never transfers to a payer, but instead the clinical data remains at data repository 122 (also referred to as a data store), which can sit behind a protected firewall (e.g., behind a provider firewall). This allows the provider to have complete control over the clinical data at all times. Furthermore, a key may be required to access the clinical data as well. The key may be utilized by a provider certificate or hospital certificate to access the clinical data. Thus a provider may send the link (e.g., using messaging component 140) with the information (e.g., provider certificate) that links the key to the data repository 122 (or numerous data repositorties). In an aspect, the data repository 122 can be employed to store information (e.g., sets of clinical data) local to the provider.

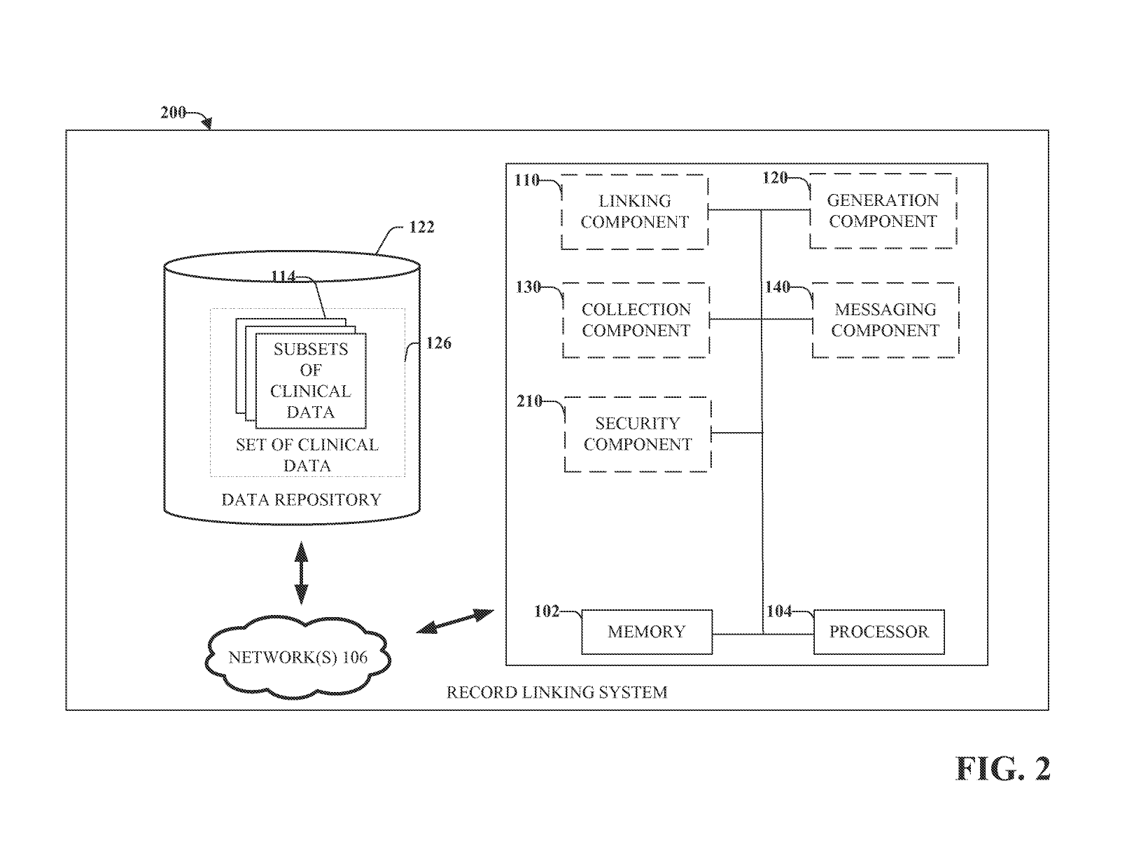

Turning now to FIG. 2, presented is another non-limiting embodiment of system 200 that links medical records via a claim message in accordance with the subject disclosure. In an aspect, system 200 can comprise the components disclosed in system 100. Furthermore, system 200 can further comprise security component 210 that receives requests to access the first subset of clinical data and a submitted access key. In an aspect, system 200 discloses the capability of protecting clinical data (e.g., set of clinical data 126, subsets of clinical data 114, etc.) via a submitted access key (e.g., key certificate, digital certificate, identity certificate) which is an electronic document that proves ownership of a key to access the clinical data. Thus, the submitted access key can comprise information about the owner's identity including a digital signature of an entity. The submitted access key can be verified as to whether the contents are correct or incorrect (e.g., using permission component 310) and allow access or reject access to the clinical data accordingly.

In an aspect, a provider and/or a payer can be approved owner's of a certificate and particular users within such organizations can be approved users of various clinical data associated with a claim. Also, collection component 130 collects descriptive information that can be used (e.g., by permission component 310) to verify a users access to the clinical data for particular reasons (e.g., evidencing payment justification of a particular medical claim). Furthermore, the user (e.g., provider) sending a message (e.g., using messaging component 140) has control of the clinical data and the means to provide a link embedded with information to facilitate data access using a key. As such, a sender of the message with the embedded link (e.g., provider) may organize a list of approved users (e.g., payers, provider clearinghouse, payer clearinghouse, etc.) to access particular clinical data (e.g., data associated with various patients and various particular claims).

Thus, in a non-limiting example, a payer can receive a claim message with embedded link. Also, because the message has an embedded link, it can pass each of the edits required by each party between the beginning location and the end destination. After reaching the end destination (e.g., payer location), the payer can run the claim through auto-adjudication rules and if the claim does not auto-adjudicate, the claim message can be assigned to an examiner. If the examiner needs clinical information, then they can click on the link embedded in the claim message and obtain access to the presented information. In an embodiment, the examiner can register with system 200 or other disclosed systems (e.g., at a website), and provide descriptive information including who will view the clinical information and why (e.g., verify the why meets the Minimum Necessary Rules). If the Examiner is approved to view the descriptive information, then the Examiner can access and in some embodiments download the clinical information (e.g., as a PDF or other standardized clinical message). In an aspect, system 200 and other systems disclosed herein facilitates the transfer of clinical information only as necessary (e.g., for claim payment justification) otherwise the clinical information remains at data repostiory 122 (e.g., at a secure location, in the providers control).

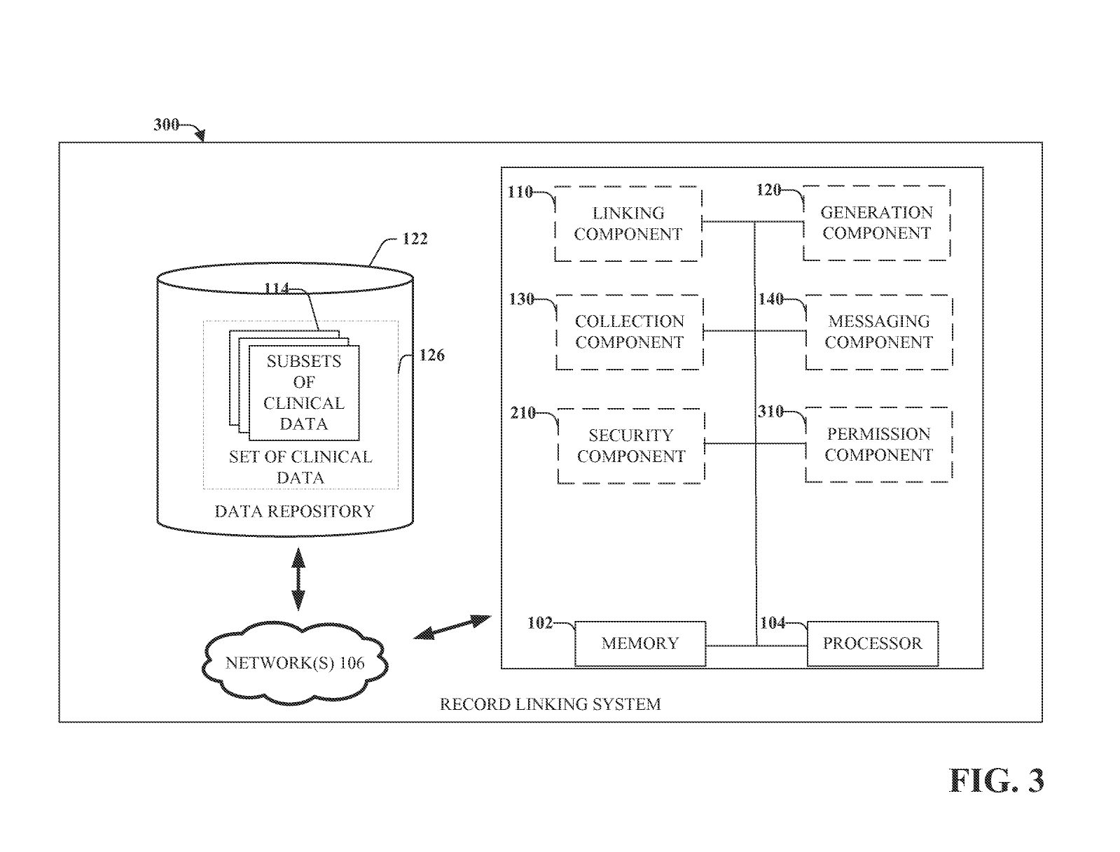

Turning now to FIG. 3, presented is another non-limiting embodiment of system 300 that links medical records via a claim message in accordance with the subject disclosure. In an aspect, system 300 can comprise the components disclosed in system 200 or any other disclosed embodiments. Furthermore, system 300 can further comprise permission component 310 that permits access to the first subset of clinical data in response to the security component 210 receiving a valid access key, wherein the valid access key is a provider (e.g., physician, hospital, affilate, etc.) certificate. In an aspect, permission component 310 can verify the collected descriptive information (e.g., collected using collection component 130) and the submitted access key to grant access to the first clinical data provided by the link. The grant of access can verify the user's authorization to access the clinical data and the necessity of such clinical data in relation to for instance, a particular medical claim. Permissions component 310 can deny access to the clinical data if there is too much data to be accessed above and beyond what is necessary to justifty the claim payment or if the user requesting access is unauthorized (e.g., doesn't have the correct credentials, provided insufficient/incorrect descriptive information, or can't procure a proper access key).

As a non-limiting example, of system 100-300, a provider may link a PHI (e.g., providers billing invoice number) to a set of clinical data (e.g., records of a patients visit to a provider for cancer treatment) using linking component 110. The provider may then generate a link (e.g., using generation component 120) that comprises a set of characters allowable by the claim message requirements of ASC X12 837 and the link is connected to the PHI or billing invoice number. The generated link can represent a very limited set of clinical information (e.g., first subset of clinical data) and clinical data that corresponds to a medical claim seeking payment for providing radiation therapy for the patient. Thus, although the provider has stored (e.g., at a data repository 122) information such as dictated notes, x-ray images, ultraound images, medication levels, patient diagnostics, EMR data, various specialists opinions, patient vitals, and other such information related to the patients care, the link only provides access to the subset of data as may be required for payment.

The message (e.g., with the medical claim) with the embedded link is sent (e.g., using messaging component 140) to the payer for payment of the medical claim and providers services to the patient. The claim examiner after receiving the message and medical claim to pay the provider for the radiation treatment of the patient then requests to open the link (e.g., by clicking on the link) and provides descriptive information about the examiner's name and reason for requesting access to the ultrasound image (e.g., to justify payment of the medical claim). The collection component 130 collects such information along with a request to access the ultrasound image. The security component 210 can then receive the request to access the first subset of clinical data (e.g., ultrasound image) along with a submitted access key (e.g., provider certificate or payer certificate). System 300 can employ permission component 310 to permit access to to the first subset of clinical data (e.g., ultrasound image) in response to the security component receiving a valid access key (e.g., providers key or payers key submitted after clicking on the link or encoded within the embedded link itself), wherein the valid access key is a provider certificate. The permission component 310 can verify the collected descriptive information (e.g., collected using collection component 130) and the validity of the key to allow access to a user. System 300 (as well as other disclosed systems herein) can thereby facilitate the justification of medical claims to a payer, satisfy the requirements to only provide the least necessary information (e.g., according to Minimum Necessary Rules), and protect PHI of patients in a secure environment.

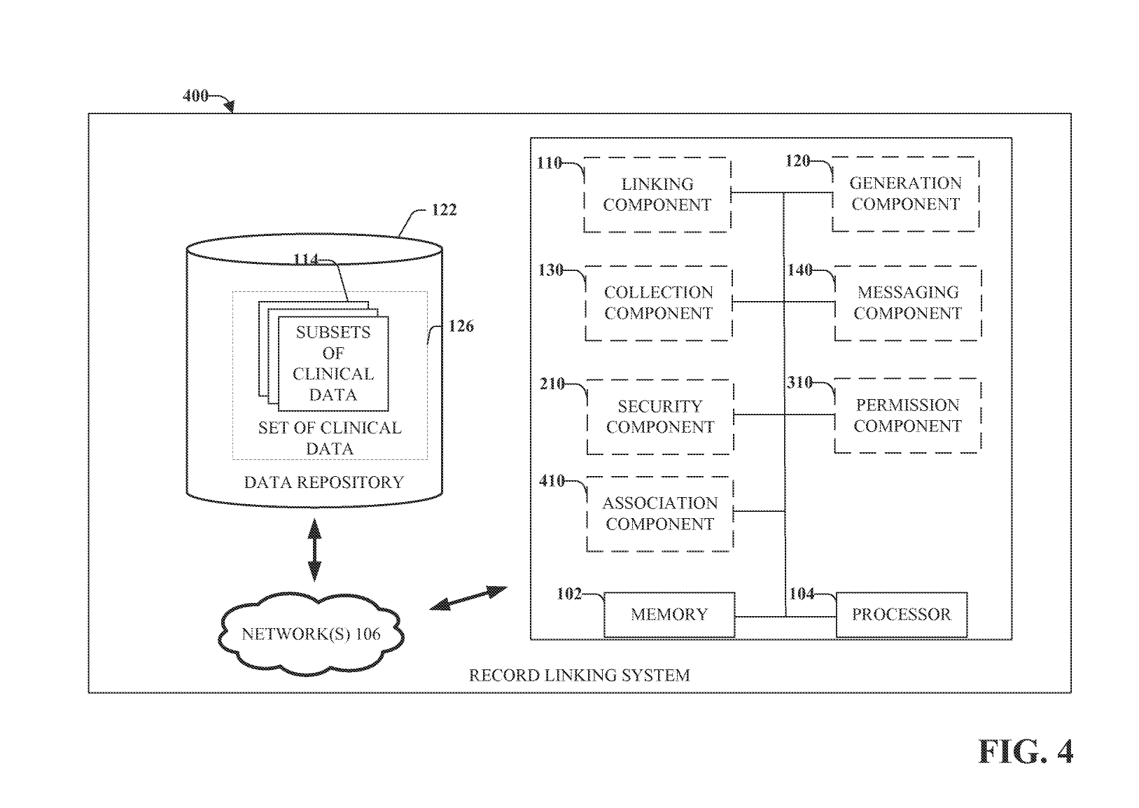

Turning now to FIG. 4, presented is another non-limiting embodiment of system 300 that links medical records via a claim message in accordance with the subject disclosure. In an aspect, system 400 can comprise the components disclosed in system 300 or any other disclosed embodiments. Furthermore, system 400 can further comprise association component 410 that associates by the system 400, subsets of clinical data of the set of clinical data with a set of insurance claims, wherein a subset of clinical data of the subsets of data corresponds with an insurance claim of the set of insurance claims. In an aspect, the set of clinical data can be organized and characterized in various ways. For instance, ICD-10 and ICD-10CM comprises codes for diseases, signs and symptoms, abnormal findings, complaints, social circumstances, external causes of indury or diseases, and various other code sets.

As such, association component 410 can associate various subsets of clinical data for a range of patients that meet the medical claim justification requirements of payers. Thus anytime a particular medical claim for a particular patient is submitted for payment to a payer, system 400 can generate a link to the specific subset of clinical data for the respective patient and send it via message to the payer (e.g., claim examiner). In an aspect, association component 410 can associate subsets of clinical data with insurance codes, medical claim classifications, payers categories and classification schemes and a host of other characterizations of the clinical data. By creating such associations, the subsets of clinical data can be accurately segmented and efficiently sent to various entities for particular purposes.

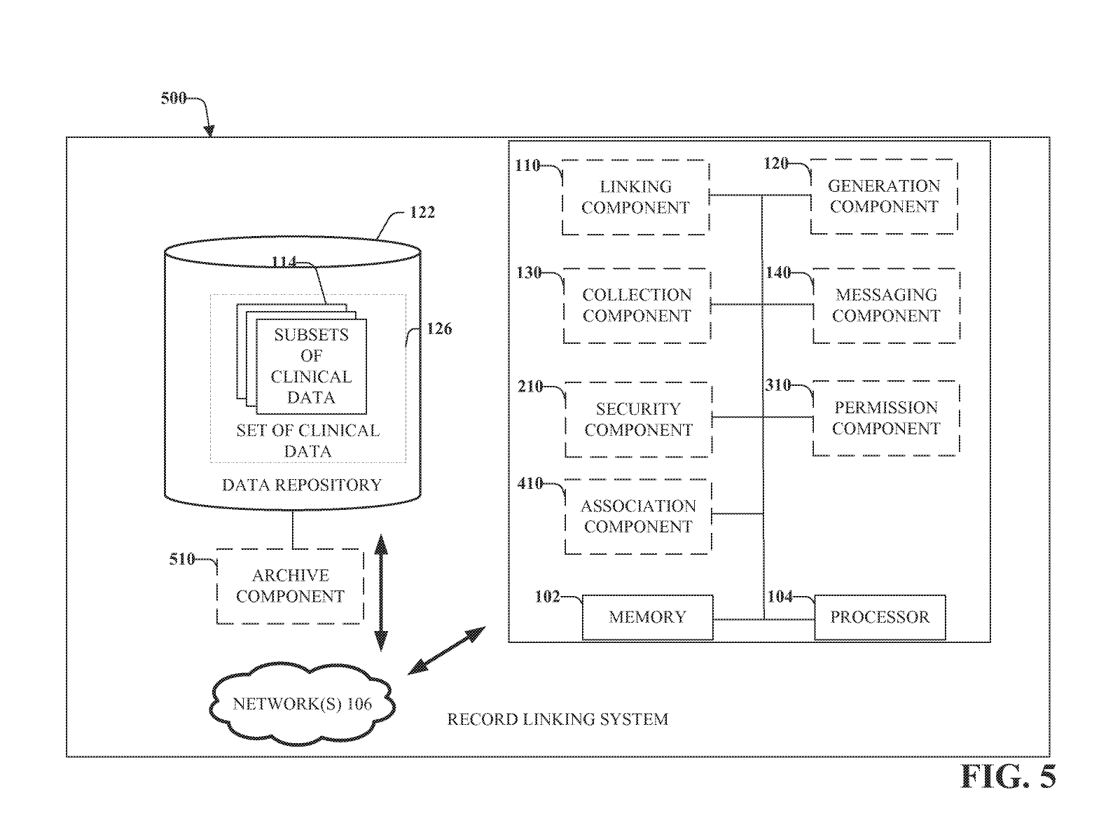

Turning now to FIG. 5, presented is another non-limiting embodiment of system 400 that links medical records via a claim message in accordance with the subject disclosure. In an aspect, system 500 can comprise the components disclosed in system 400 or any other disclosed embodiments. Furthermore, system 500 can further comprise an archive component 510 that archives the set of clinical data 126, the subsets of clinical data 114, and the set of insurance claims at the data repository 122. In an aspect, the clinical data (which includes data required to determine pricing by hospital providers and payers) and insurance claim information can be stored at a data repository 122. Furthermore, the stored clinical data and other information can be archived (e.g., using archive component 510) to allow physicians and authorized health care providers to obtain access to the clinical data in an FDA approved diagnostic viewing capacity in web browsers and at mobile devices. Thus, archive component 510 can archive such data at data repository 122 to facilitate the sharing of clinical data in an easy, and quickly implemented manner.

In an aspect, archive component 510 can store and manage all medical types of content (e.g., discreet medical data, HL7 and PDF results, a range of image modalities such as DICOM and ultrasound images, etc.) and clinical data on one platform. Furthermore, in another aspect, archive component 510 can integrate the archived content and clinical data into an organizations (e.g., hospital) existing security infrastructure wherein users can simply click and get the information needed. This capability of facilitating a unified platform that securely stores structured and unstructured as well as related and unrelated content, and clinical data into a a single repository can assist in the achievement of organizations interoperability objectives. The single archived repository also provides a rich array of information to satisfy the clincial data needs of a robust array of medical claim evidentiary requirements.

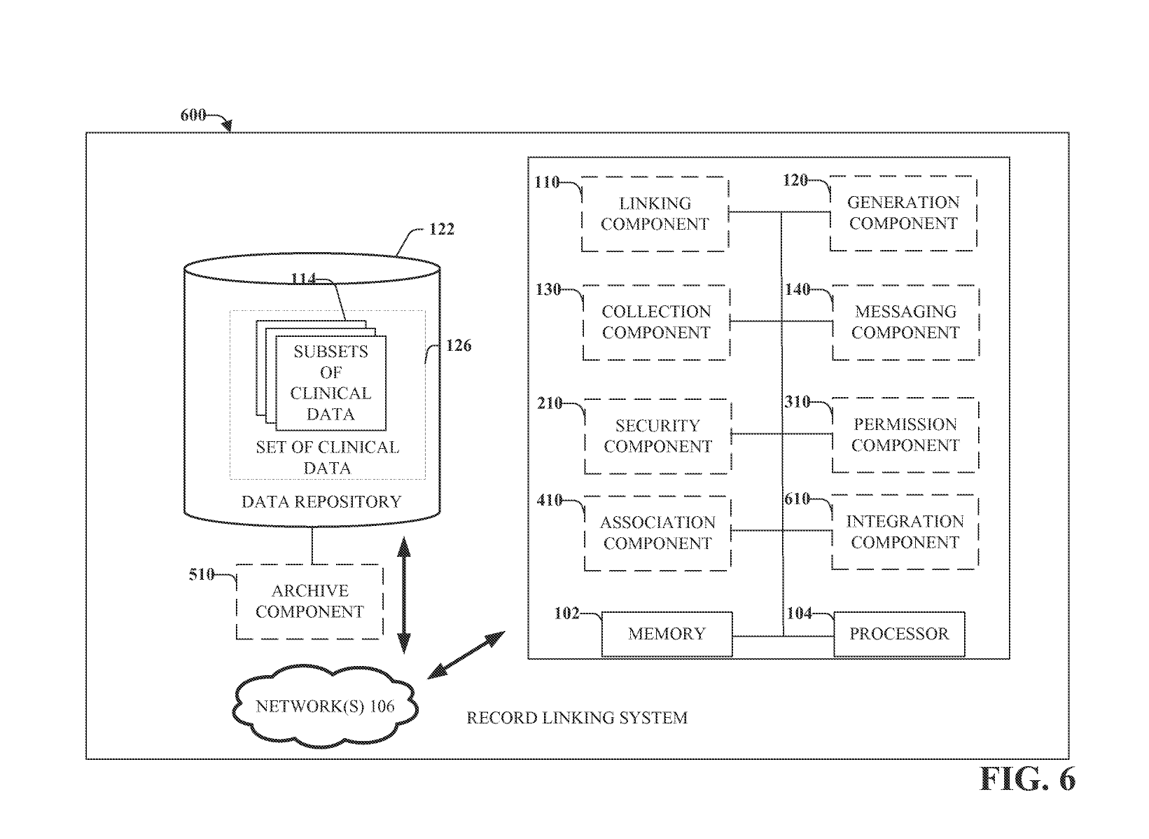

Turning now to FIG. 6, presented is another non-limiting embodiment of system 500 that links medical records via a claim message in accordance with the subject disclosure. In an aspect, system 600 can comprise the components disclosed in system 500 or any other disclosed embodiments herein. Furthermore, system 600 can further comprise integration component 610 that integrates the system with an electronic management record system. In an aspect, a provider may utilize a claim management system or an electronic medical record system (EMR) to generate documentation to satisfy a medical claim payment evidentiary requirements. Thus, in an aspect, system 600 and other embodiments disclosed herein can integrate with the claim management system or EMR to access the necessary clinical data (e.g., operations notes, physician notes, etc.) to justify a medical claim payment. The message can be sent (e.g., using messaging component 410) with embedded link that links to one or more system (e.g., data repository 122, EMR system, claim management system). Also, generation component 130 can generate a link that connects to a variety of sources or one integrated source comprising a compilation of clinical data and information from a variety of sources (e.g., a transcription system, an EMR).

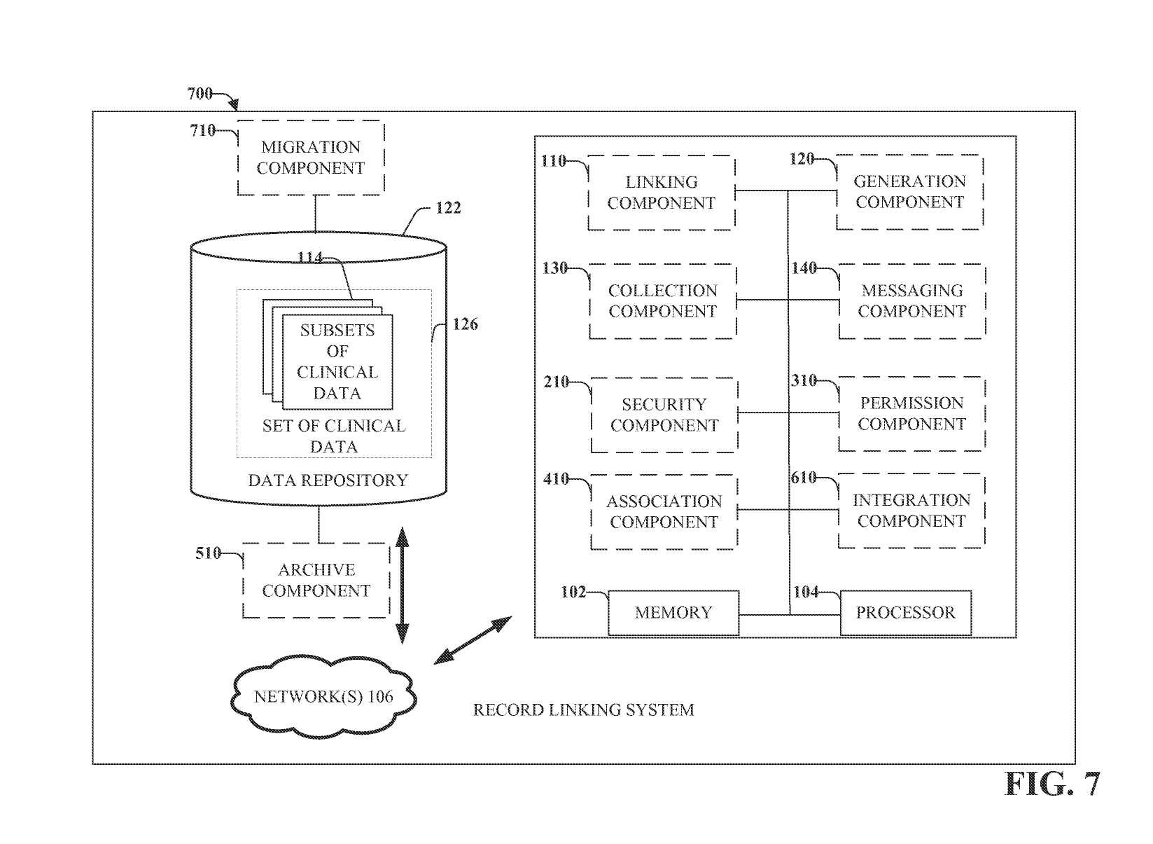

Turning now to FIG. 7, presented is another non-limiting embodiment of system 600 that links medical records via a claim message in accordance with the subject disclosure. In an aspect, system 700 can comprise the components disclosed in system 700 or any other disclosed embodiments herein. Furthermore, system 700 can further comprise migration component 710 that migrates the set of clinical data from disparate databases to a central data store. In an aspect, migration component 710 can bring together data from various locations (e.g., EMR system, transcription system, claim management system, provider servers, data marts, data warehouses, etc.) and store the data at data repository 122. In another aspect, migration component 710 can facilitate access to clinical data from disparate source to be accessed at one centralized location. In an aspect, migration component 710 can make use of data transformation techniques to bring together and identify data at one location. Migration component 710 can also extract identified data from data sources and place them into data repository 122, a data depot, or a staging area for refining. The data can then me integrated under a common data architecture.

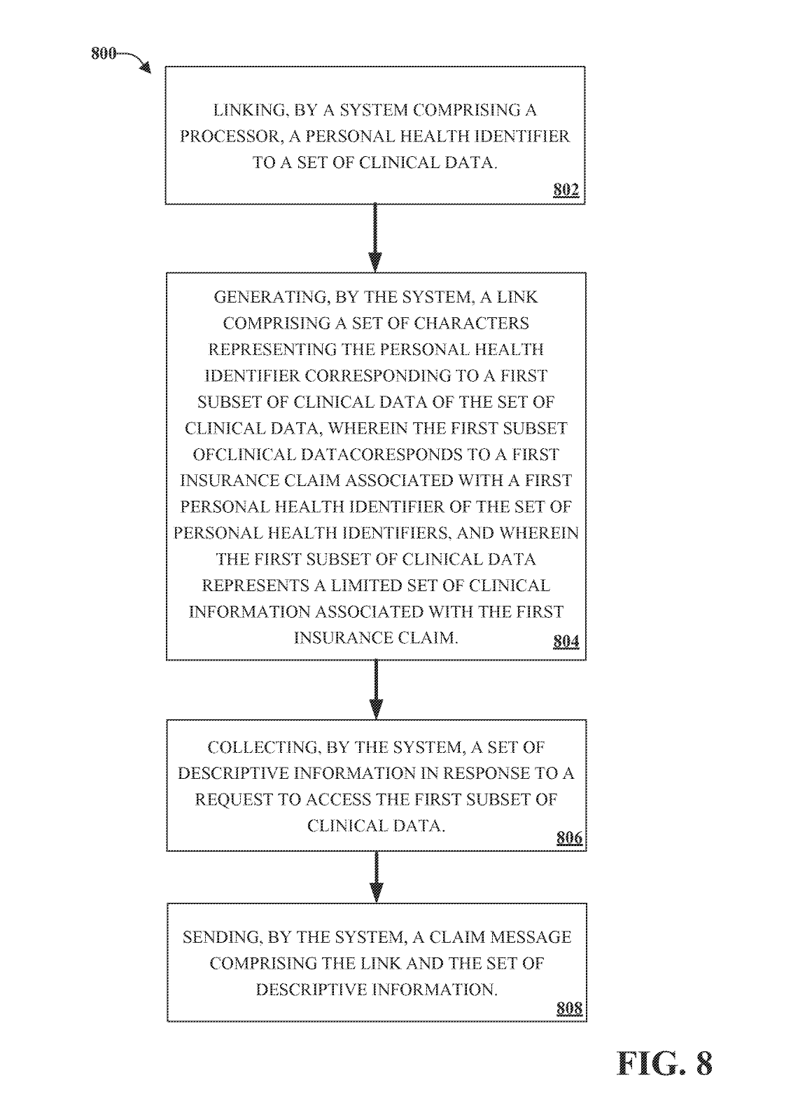

In view of the example systems and/or devices described herein, example methods that can be implemented in accordance with the disclosed subject matter can be further appreciated with reference to flowcharts in FIGS. 8-12. For purposes of simplicity of explanation, example methods disclosed herein are presented and described as a series of acts; however, it is to be understood and appreciated that the disclosed subject matter is not limited by the order of acts, as some acts may occur in different orders and/or concurrently with other acts from that shown and described herein.

For example, a method disclosed herein could alternatively be represented as a series of interrelated states or events, such as in a state diagram. Moreover, interaction diagram(s) may represent methods in accordance with the disclosed subject matter when disparate entities enact disparate portions of the methods. Furthermore, not all illustrated acts may be required to implement a method in accordance with the subject specification. It should be further appreciated that the methods disclosed throughout the subject specification are capable of being stored on an article of manufacture to facilitate transporting and transferring such methods to computers for execution by a processor or for storage in a memory.

FIG. 8 illustrates a flow chart of an example method 800 for linking medical records to a medical claim message in accordance with aspects described herein. At 802, a personal health identifier is linked (e.g., via linking component 110), by a system comprising a processor, to a set of clinical data. At 804, a link comprising a set of characters representing the personal health identifier corresponding to a first subset of clinical data of the set of clinical data is generated (e.g., via generation component 120) by the system, wherein the first subset of clinical data corresponds to a first insurance claim associated with a first personal health identifier of the set of personal health identifiers, and wherein the first subset of clinical data represents a limited set of clinical information associated with the first insurance claim. In an aspect, the set of characters comprise a set of capital letters, a set of numbers, and a set of periods. At 806, a set of descriptive information is collected by the system (e.g., using collection component 130) in response to a request to access the first subset of clinical data. At 808, a claim message is sent (e.g. using messaging component 140) by the system comprising the link and the set of descriptive information.

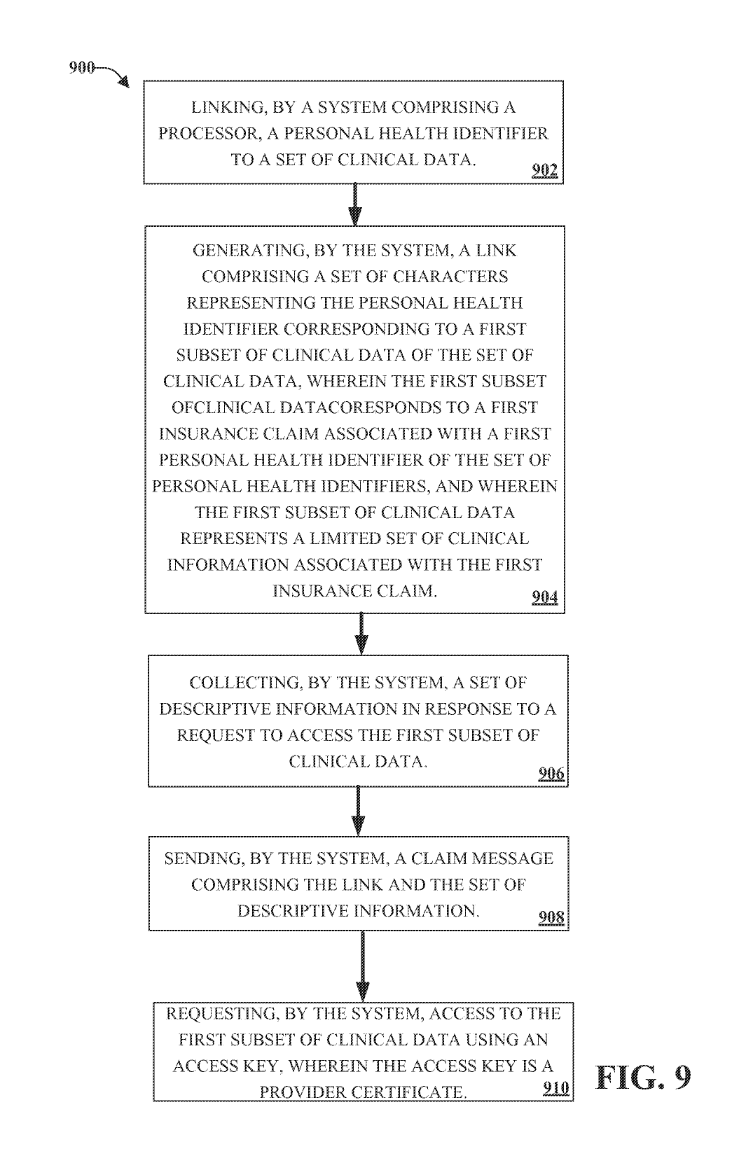

FIG. 9 illustrates a flow chart of an example method 900 for linking medical records to a medical claim message in accordance with aspects described herein. At 902, a personal health identifier is linked (e.g., via linking component 110), by a system comprising a processor, to a set of clinical data. At 904, a link comprising a set of characters representing the personal health identifier corresponding to a first subset of clinical data of the set of clinical data is generated (e.g., via generation component 120) by the system, wherein the first subset of clinical data corresponds to a first insurance claim associated with a first personal health identifier of the set of personal health identifiers, and wherein the first subset of clinical data represents a limited set of clinical information associated with the first insurance claim.

In an aspect, the subsets of clinical data and the set of insurance claims are stored at a data repository 122. At 906, a set of descriptive information is collected by the system (e.g., using collection component 130) in response to a request to access the first subset of clinical data. At 908, a claim message is sent (e.g. using messaging component 140) by the system comprising the link and the set of descriptive information. At 910, access to the first subset of clinical data is requested by the system (e.g., using security component 210) using an access key, wherein the access key is a provider certificate. In an aspect, the claim message is an ANSI ASC X12 837 claim message, wherein the ANSI ASC X12N 837 claim is configured to an ANSI ASC X12N 837 system format.

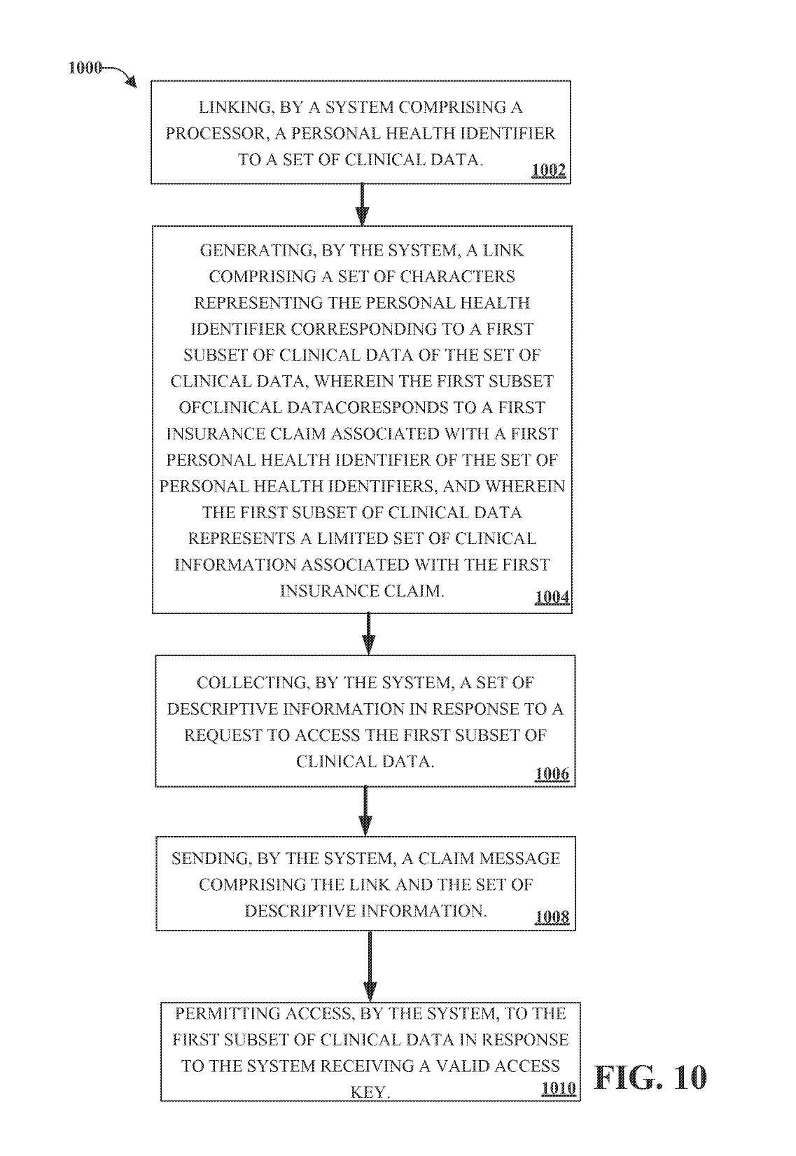

FIG. 10 illustrates a flow chart of an example method 1000 for linking medical records to a medical claim message in accordance with aspects described herein. At 1002, a personal health identifier is linked (e.g., via linking component 110), by a system comprising a processor, to a set of clinical data. At 1004, a link comprising a set of characters representing the personal health identifier corresponding to a first subset of clinical data of the set of clinical data is generated (e.g., via generation component 120) by the system, wherein the first subset of clinical data corresponds to a first insurance claim associated with a first personal health identifier of the set of personal health identifiers, and wherein the first subset of clinical data represents a limited set of clinical information associated with the first insurance claim. In an aspect, the set of characters comprise a set of capital letters, a set of numbers, and a set of periods. At 1006, descriptive information is collected by the system (e.g., using collection component 130) in response to a request to access the first subset of clinical data. At 1008, a claim message is sent (e.g. using messaging component 140) by the system comprising the link and the set of descriptive information. At 1010, the system permits access (e.g., using permission component 310) to the first subset of clinical data in response to the system receiving a valid access key.

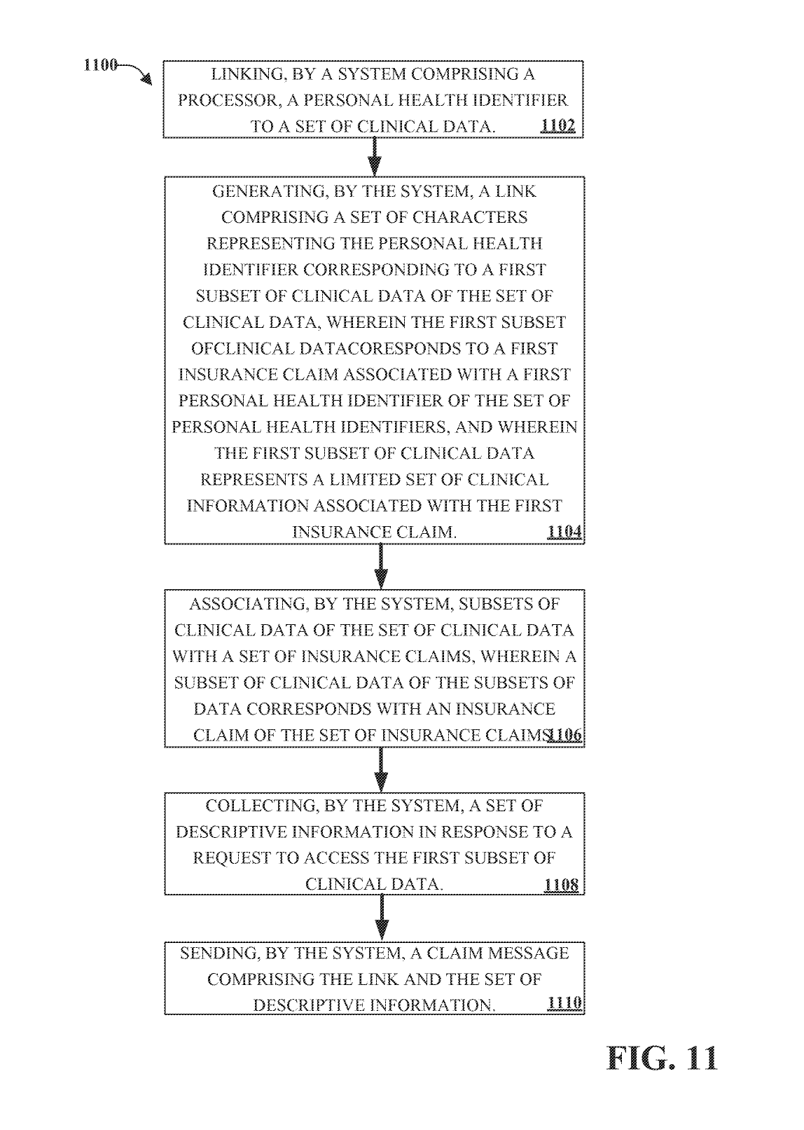

FIG. 11 illustrates a flow chart of an example method 1100 for linking medical records to a medical claim message in accordance with aspects described herein. At 1102, a personal health identifier is linked (e.g., via linking component 110), by a system comprising a processor, to a set of clinical data. At 1104, a link comprising a set of characters representing the personal health identifier corresponding to a first subset of clinical data of the set of clinical data is generated (e.g., via generation component 120) by the system, wherein the first subset of clinical data corresponds to a first insurance claim associated with a first personal health identifier of the set of personal health identifiers, and wherein the first subset of clinical data represents a limited set of clinical information associated with the first insurance claim. In an aspect, the set of characters comprise a set of capital letters, a set of numbers, and a set of periods. At 1106, the system associates subsets of clinical data of the set of clinical data with a set of insurance claims, wherein a subset of clinical data of the subsets of data corresponds with an insurance claim of the set of insurance claims. At 1108, descriptive information is collected by the system (e.g., using collection component 130) in response to a request to access the first subset of clinical data. At 1110, a claim message is sent (e.g. using messaging component 140) by the system comprising the link and the set of descriptive information.

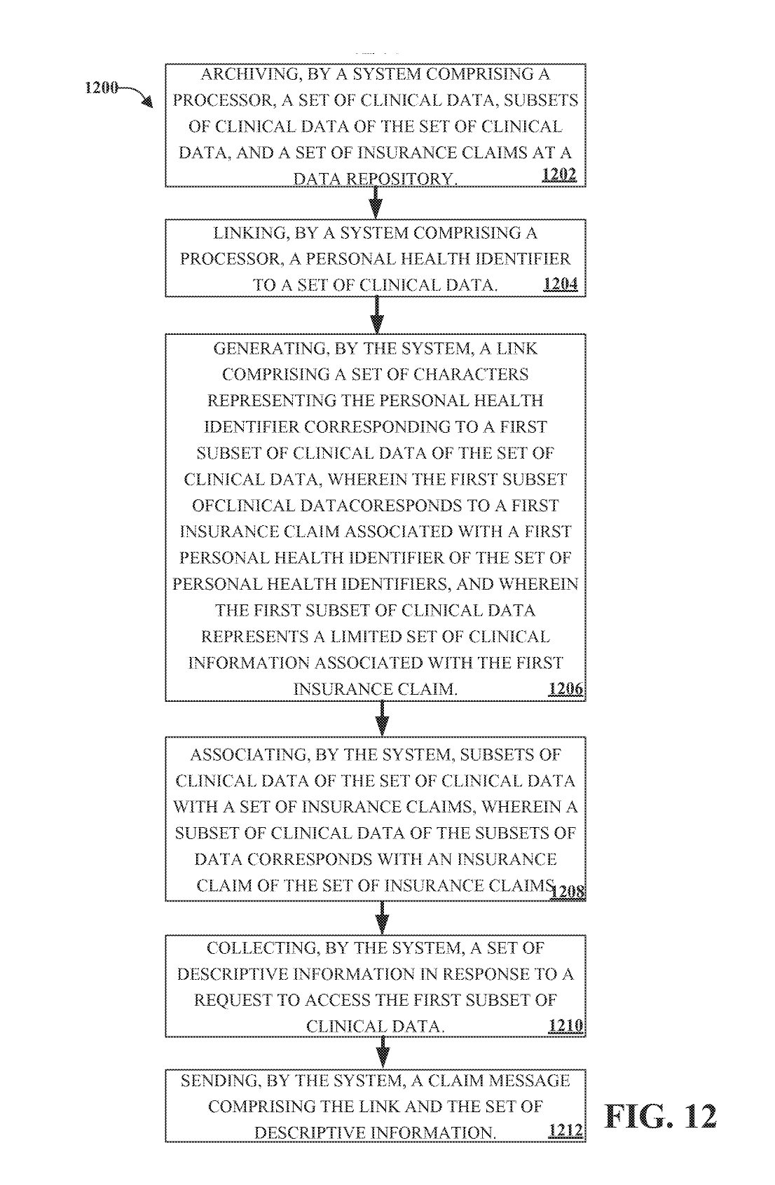

FIG. 12 illustrates a flow chart of an example method 1200 for linking medical records to a medical claim message in accordance with aspects described herein. At 1202, a set of clinical data, subsets of clinical data of the set of clinical data, and a set of insurance claims are archived by the system (e.g., using archive component 510) at a data repository 122. At 1204, a personal health identifier is linked (e.g., via linking component 110), by a system comprising a processor, to a set of clinical data. At 1206, a link comprising a set of characters representing the personal health identifier corresponding to a first subset of clinical data of the set of clinical data is generated (e.g., via generation component 120) by the system, wherein the first subset of clinical data corresponds to a first insurance claim associated with a first personal health identifier of the set of personal health identifiers, and wherein the first subset of clinical data represents a limited set of clinical information associated with the first insurance claim. In an aspect, the set of characters comprise a set of capital letters, a set of numbers, and a set of periods. At 1208, descriptive information is collected by the system (e.g., using collection component 130) in response to a request to access the first subset of clinical data. At 1210, a claim message is sent (e.g. using messaging component 140) by the system comprising the link and the set of descriptive information. At 1212, the system permits access to the first subset of clinical data in response to the system receiving a valid access key.

### Example Operating Environments

The systems and processes described below can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders, not all of which may be explicitly illustrated in this disclosure.

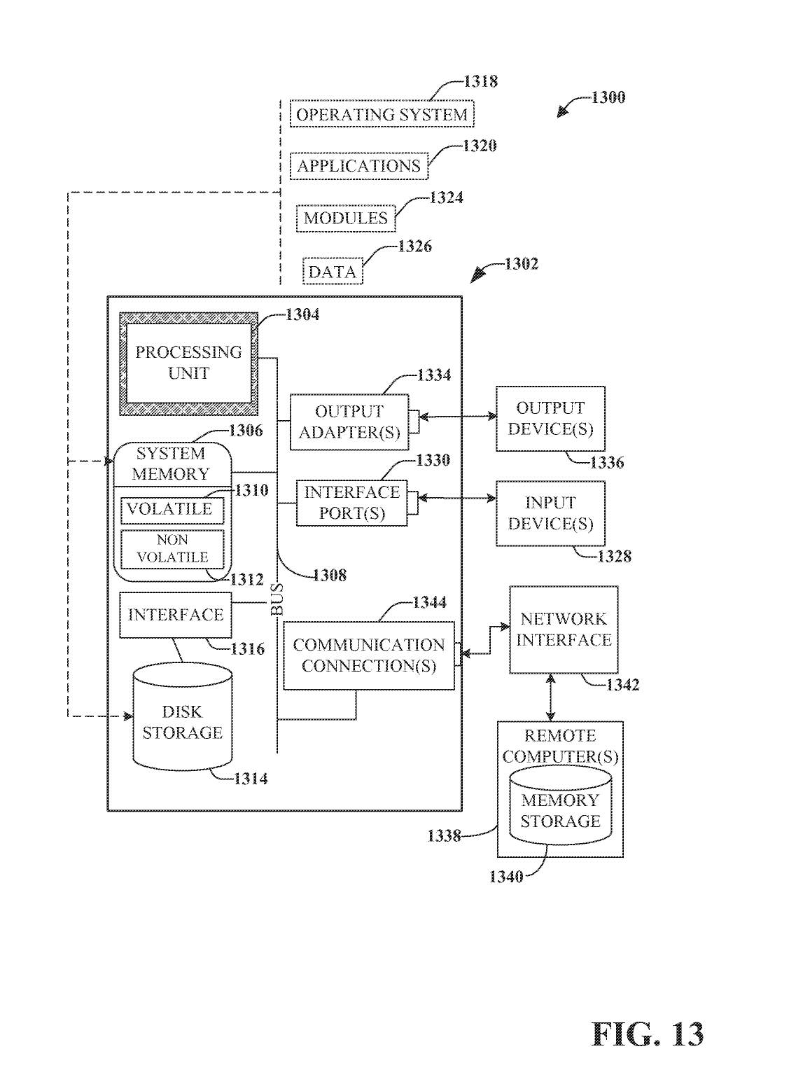

With reference to FIG. 13, a suitable environment 1300 for implementing various aspects of the claimed subject matter includes a computer 1302. The computer 1302 includes a processing unit 1304, a system memory 1306, a codec 1305, and a system bus 1308. The system bus 1308 couples system components including, but not limited to, the system memory 1306 to the processing unit 1304. The processing unit 1304 can be any of various available suitable processors. Dual microprocessors and other multiprocessor architectures also can be employed as the processing unit 1304.

The system bus 1308 can be any of several types of suitable bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA). Fire wire (IEEE 10104), and Small Computer Systems Interface (SCSI).

The system memory 1306 includes volatile memory 1310 and non-volatile memory 1312. The basic input/output system (BIOS), containing the basic routines to transfer information between elements within the computer 1302, such as during start-up, is stored in non-volatile memory 1312. In addition, according to present innovations, codec 1305 may include at least one of an encoder or decoder, wherein the at least one of an encoder or decoder may consist of hardware, a combination of hardware and software, or software. Although, codec 1305 is depicted as a separate component, codec 1305 may be contained within non-volatile memory 1312. By way of illustration, and not limitation, non-volatile memory 1312 can include read only memory (ROM), programmable ROM (PROM), electrically programmable ROM (EPROM), electrically erasable programmable ROM (EEPROM), or flash memory. Volatile memory 1310 includes random access memory (RAM), which acts as external cache memory. According to present aspects, the volatile memory may store the write operation retry logic (not shown in FIG. 13) and the like. By way of illustration and not limitation, RAM is available in many forms such as static RAM (SRAM), dynamic RAM (DRAM), synchronous DRAM (SDRAM), double data rate SDRAM (DDR SDRAM), and enhanced SDRAM (ESDRAM.

Computer 1302 may also include removable/non-removable, volatile/non-volatile computer storage medium. FIG. 13 illustrates, for example, disk storage 1314. Disk storage 1314 includes, but is not limited to, devices like a magnetic disk drive, solid state disk (SSD) floppy disk drive, tape drive, Jaz drive. Zip drive, LS-70 drive, flash memory card, or memory stick. In addition, disk storage 1314 can include storage medium separately or in combination with other storage medium including, but not limited to, an optical disk drive such as a compact disk ROM device (CD-ROM). CD recordable drive (CD-R Drive). CD rewritable drive (CD-RW Drive) or a digital versatile disk ROM drive (DVD-ROM). To facilitate connection of the disk storage devices 1314 to the system bus 1308, a removable or non-removable interface is typically used, such as interface 1316.

It is to be appreciated that FIG. 13 describes software that acts as an intermediary between users and the basic computer resources described in the suitable operating environment 1300. Such software includes an operating system 1318. Operating system 1318, which can be stored on disk storage 1314, acts to control and allocate resources of the computer system 1302. Applications 1320 take advantage of the management of resources by operating system 1318 through program modules 1324, and program data 1326, such as the boot/shutdown transaction table and the like, stored either in system memory 1306 or on disk storage 1314. It is to be appreciated that the claimed subject matter can be implemented with various operating systems or combinations of operating systems.

A user enters commands or information into the computer 1302 through input device(s) 1328. Input devices 1328 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1304 through the system bus 1308 via interface port(s) 1330. Interface port(s) 1330 include, for example, a serial port, a parallel port, a game port, and a universal serial bus (USB). Output device(s) 1336 use some of the same type of ports as input device(s). Thus, for example, a USB port may be used to provide input to computer 1302, and to output information from computer 1302 to an output device 1336. Output adapter 1334 is provided to illustrate that there are some output devices 1336 like monitors, speakers, and printers, among other output devices 1336, which require special adapters. The output adapters 1334 include, by way of illustration and not limitation, video and sound cards that provide a means of connection between the output device 1336 and the system bus 1308. It should be noted that other devices and/or systems of devices provide both input and output capabilities such as remote computer(s) 1338.

Computer 1302 can operate in a networked environment using logical connections to one or more remote computers, such as remote computer(s) 1338. The remote computer(s) 1338 can be a personal computer, a server, a router, a network PC, a workstation, a microprocessor based appliance, a peer device, a smart phone, a tablet, or other network node, and typically includes many of the elements described relative to computer 1302. For purposes of brevity, only a memory storage device 1340 is illustrated with remote computer(s) 1338. Remote computer(s) 1338 is logically connected to computer 1302 through a network interface 1342 and then connected via communication connection(s) 1344. Network interface 1342 encompasses wire and/or wireless communication networks such as local-area networks (LAN) and wide-area networks (WAN) and cellular networks. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1344 refers to the hardware/software employed to connect the network interface 1342 to the bus 1308. While communication connection 1344 is shown for illustrative clarity inside computer 1302, it can also be external to computer 1302. The hardware/software necessary for connection to the network interface 1342 includes, for exemplary purposes only, internal and external technologies such as, modems including regular telephone grade modems, cable modems and DSL modems, ISDN adapters, and wired and wireless Ethernet cards, hubs, and routers.

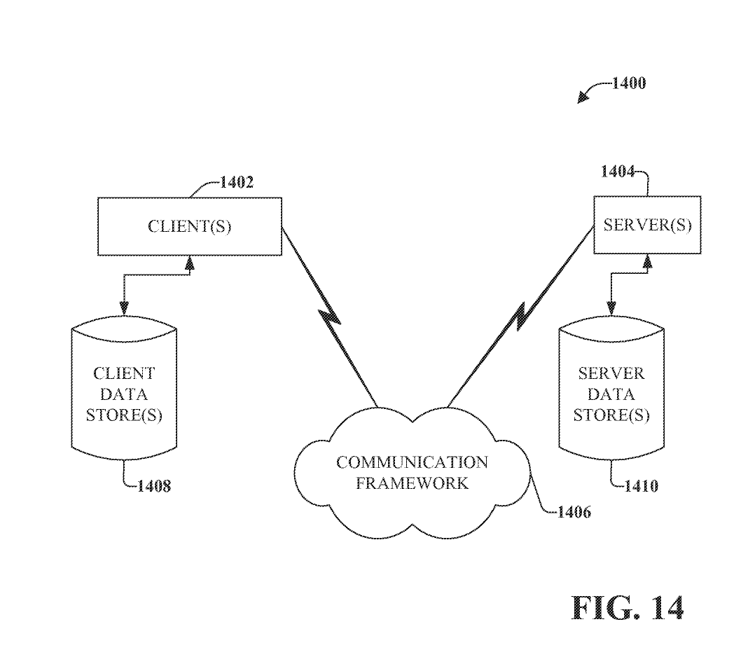

Referring now to FIG. 14, there is illustrated a schematic block diagram of a computing environment 1400 in accordance with this disclosure. The system 1400 includes one or more client(s) 1402 (e.g., laptops, smart phones, PDAs, media players, computers, portable electronic devices, tablets, and the like). The client(s) 1402 can be hardware and/or software (e.g., threads, processes, computing devices). The system 1400 also includes one or more server(s) 1404. The server(s) 1404 can also be hardware or hardware in combination with software (e.g., threads, processes, computing devices). The servers 1404 can house threads to perform transformations by employing aspects of this disclosure, for example. One possible communication between a client 1402 and a server 1404 can be in the form of a data packet transmitted between two or more computer processes wherein the data packet may include video data. The data packet can include a metadata, e.g., associated contextual information, for example. The system 1400 includes a communication framework 1406 (e.g., a global communication network such as the Internet, or mobile network(s)) that can be employed to facilitate communications between the client(s) 1402 and the server(s) 1404.

Communications can be facilitated via a wired (including optical fiber) and/or wireless technology. The client(s) 1402 include or are operatively connected to one or more client data store(s) 1408 that can be employed to store information local to the client(s) 1402 (e.g., associated contextual information). Similarly, the server(s) 1404 are operatively include or are operatively connected to one or more server data store(s) 1410 that can be employed to store information local to the servers 1404.

In one embodiment, a client 1402 can transfer an encoded file, in accordance with the disclosed subject matter, to server 1404. Server 1404 can store the file, decode the file, or transmit the file to another client 1402. It is to be appreciated, that a client 1402 can also transfer uncompressed file to a server 1404 and server 1404 can compress the file in accordance with the disclosed subject matter. Likewise, server 1404 can encode video information and transmit the information via communication framework 1406 to one or more clients 1402.

The illustrated aspects of the disclosure may also be practiced in distributed computing environments where certain tasks are performed by remote processing devices that are linked through a communications network. In a distributed computing environment, program modules can be located in both local and remote memory storage devices.

Moreover, it is to be appreciated that various components described in this description can include electrical circuit(s) that can include components and circuitry elements of suitable value in order to implement the embodiments of the subject innovation(s). Furthermore, it can be appreciated that many of the various components can be implemented on one or more integrated circuit (IC) chips. For example, in one embodiment, a set of components can be implemented in a single IC chip. In other embodiments, one or more of respective components are fabricated or implemented on separate IC chips.

What has been described above includes examples of the embodiments of the present invention. It is, of course, not possible to describe every conceivable combination of components or methodologies for purposes of describing the claimed subject matter, but it is to be appreciated that many further combinations and permutations of the subject innovation are possible. Accordingly, the claimed subject matter is intended to embrace all such alterations, modifications, and variations that fall within the spirit and scope of the appended claims. Moreover, the above description of illustrated embodiments of the subject disclosure, including what is described in the Abstract, is not intended to be exhaustive or to limit the disclosed embodiments to the precise forms disclosed. While specific embodiments and examples are described in this disclosure for illustrative purposes, various modifications are possible that are considered within the scope of such embodiments and examples, as those skilled in the relevant art can recognize.

In particular and in regard to the various functions performed by the above described components, devices, circuits, systems and the like, the terms used to describe such components are intended to correspond, unless otherwise indicated, to any component which performs the specified function of the described component (e.g., a functional equivalent), even though not structurally equivalent to the disclosed structure, which performs the function in the disclosure illustrated exemplary aspects of the claimed subject matter. In this regard, it will also be recognized that the innovation includes a system as well as a computer-readable storage medium having computer-executable instructions for performing the acts and/or events of the various methods of the claimed subject matter.

The aforementioned systems/circuits/modules have been described with respect to interaction between several components/blocks. It can be appreciated that such systems/circuits and components/blocks can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described in this disclosure may also interact with one or more other components not specifically described in this disclosure but known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), a combination of hardware and software, software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. Further, a “device” can come in the form of specially designed hardware; generalized hardware made specialized by the execution of software thereon that enables the hardware to perform specific function; software stored on a computer readable storage medium; software transmitted on a computer readable transmission medium; or a combination thereof.

Moreover, the words “example” or “exemplary” are used in this disclosure to mean serving as an example, instance, or illustration. Any aspect or design described in this disclosure as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Computing devices typically include a variety of media, which can include computer-readable storage media and/or communications media, in which these two terms are used in this description differently from one another as follows. Computer-readable storage media can be any available storage media that can be accessed by the computer, is typically of a non-transitory nature, and can include both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

On the other hand, communications media typically embody computer-readable instructions, data structures, program modules or other structured or unstructured data in a data signal that can be transitory such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

In view of the exemplary systems described above, methodologies that may be implemented in accordance with the described subject matter will be better appreciated with reference to the flowcharts of the various figures. For simplicity of explanation, the methodologies are depicted and described as a series of acts. However, acts in accordance with this disclosure can occur in various orders and/or concurrently, and with other acts not presented and described in this disclosure. Furthermore, not all illustrated acts may be required to implement the methodologies in accordance with certain aspects of this disclosure. In addition, those skilled in the art will understand and appreciate that the methodologies could alternatively be represented as a series of interrelated states via a state diagram or events. Additionally, it should be appreciated that the methodologies disclosed in this disclosure are capable of being stored on an article of manufacture to facilitate transporting and transferring such methodologies to computing devices. The term article of manufacture, as used in this disclosure, is intended to encompass a computer program accessible from a computer-readable device or storage media.

What is claimed is:

1. A system, comprising:
a memory that stores computer executable components;
a processor that executes at least the following computer executable components stored in the memory:
a linking component that links a personal health identifier to a set of clinical data;
a generation component that generates a link comprising a set of characters representing the personal health identifier corresponding to a first subset of clinical data of the set of clinical data, wherein the generating the link is based on a first claim associated with the personal health identifier, and wherein the first subset of clinical data represents a limited set of clinical information corresponding to the first claim;
a collection component that collects a set of descriptive information in response to a request to access the first subset of clinical data; and
a messaging component that sends an electronic claim message comprising the link embedded within the electronic claim message and the set of descriptive information.

2. The system of claim 1, further comprising a security component that receives requests to access the first subset of clinical data and a submitted access key.

3. The system of claim 2, further comprising a permission component that permits access to the first subset of clinical data in response to the security component receiving a valid access key, wherein the valid access key is a provider certificate.

4. The system of claim 1, further comprising an association component that associates by the system, subsets of clinical data of the set of clinical data with a set of insurance claims, wherein a subset of clinical data of the subsets of data corresponds with an insurance claim of the set of insurance claims.

5. The system of claim 4, wherein the subsets of clinical data and the set of insurance claims are stored at a data repository.

6. The system of claim 1, wherein the set of characters comprise a set of capital letters, a set of numbers, and a set of periods.

7. The system of claim 1, wherein the claim message is an ANSI ASC X12 837 claim message, wherein the ANSI ASC X12 837 claim is configured to an ANSI ASC X12 837 system format.

8. The system of claim 1, further comprising an archive component that archives the set of clinical data, the subsets of clinical data, and the set of insurance claims at the data repository.

9. The system of claim 1, further comprising an integration component that integrates the system with an electronic management record system.

10. The system of claim 1, further comprising, a migration component that migrates the set of clinical data from disparate databases to a central data store.

11. A method, comprising:
linking, by a system comprising a processor, a personal health identifier to a set of clinical data;
generating, by the system, a link comprising a set of characters representing the personal health identifier corresponding to a first subset of clinical data of the set of clinical data, wherein the first subset of clinical data corresponds to a first insurance claim associated with a first personal health identifier of the set of personal health identifiers, and wherein the first subset of clinical data represents a limited set of clinical information associated with the first insurance claim;
collecting, by the system, a set of descriptive information in response to a request to access the first subset of clinical data; and
sending, by the system, a claim message comprising the link and the set of descriptive information.

12. The method of claim 11, further comprising requesting, by the system, access to the first subset of clinical data using an access key, wherein the access key is a provider certificate.

13. The method of claim 12, further comprising permitting access, by the system, to the first subset of clinical data in response to the system receiving a valid access key.

14. The method of claim 11, further comprising associating, by the system, subsets of clinical data of the set of clinical data with a set of insurance claims, wherein a subset of clinical data of the subsets of data corresponds with an insurance claim of the set of insurance claims.

15. The method of claim 11, wherein the claim message is an ASC X12 837 claim message.

16. The method of claim 1, further comprising archiving, by the system, the set of clinical data, the subsets of clinical data, and the set of insurance claims at a data repository.

17. A system, comprising:
means for transferring a set of claim data from a registration system to a claim management system;
means for receiving a request to access the set of claim data from a data repository;
means for collecting a subset of claim data of the set of claim data from the data repository located at a first location in response to the request;
means for generating an embeddable link connected to the subset of claim data; and means for embedding the embeddable link to in a claim message.

18. The system of claim 17, further comprising, a means for determining the subset of claim data for the collecting based on a minimum necessary data requirement.

19. The system of claim 17, further comprising, a means for sending the claim message to the second location.

20. The system of claim 17, further comprising, a means for permitting access to the subset of claim data at the second location based on receipt, by the system, of a set of authorized security information.
